(19) United States
(12) Patent Application Publication
(10) Pub. No.: US 2008/0032719 A1
(43) Pub. Date: Feb. 7, 2008

(54) CENTRALIZED ESTABLISHMENT-BASED TRACKING AND MESSAGING SERVICE

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/772,803

(22) Filed: Jul. 2, 2007

Related U.S. Application Data
(63) Continuation-in-part of application No. 11/383,197, filed on May 12, 2006.
(63) Continuation-in-part of application No. 11/425,990, filed on Jun. 22, 2006.
(63) Continuation-in-part of application No. 11/551,702, filed on Oct. 20, 2006.
(63) Continuation-in-part of application No. 11/427,325, filed on Jun. 28, 2006.
(60) Provisional application No. 60/723,021, filed on Oct. 1, 2005.
(60) Provisional application No. 60/731,180, filed on Oct. 29, 2005.
(60) Provisional application No. 60/748,832, filed on Dec. 10, 2005.
(60) Provisional application No. 60/742,625, filed on Dec. 5, 2005.
(60) Provisional application No. 60/928,729, filed on May 10, 2007.
(60) Provisional application No. 60/906,606, filed on Mar. 12, 2007.
(60) Provisional application No. 60/918,772, filed on Mar. 17, 2007.
(60) Provisional application No. 60/922,837, filed on Apr. 10, 2007.
(60) Provisional application No. 60/925,038, filed on Apr. 14, 2007.
(60) Provisional application No. 60/925,489, filed on Apr. 20, 2007.

(51) Int. Cl. H04Q 7/20

(52) U.S. Cl. 455/466

(57) ABSTRACT

A system is provided to track customer patronage within each of a plurality of physical establishments such as restaurants, bars, and retail stores, and enable real-time establishment-specific messages to be sent directly to the portable computing devices of current and prior patrons. A centralized server that is configured to receive electronic attendance messages that indicate when a particular user is in attendance within a particular establishment and maintain an attendance database that includes current and historical patronage data. The server also executes an automated targeted messaging process by which establishment-specific messages are be sent to portable computing devices of users based upon their current and/or historical patronage. The server may also access a personal profile database that stores demographic characteristics of users. Using such personal profile data, highly targeted messaging is enabled in which establishment-specific messages are sent to users with dependence upon one or more demographic characteristics.

### RELATED APPLICATION DATA

This application is a continuation-in-part of co-pending U.S. patent application Ser. No. 11/383,197, which claims the benefit and priority of U.S. provisional patent application Ser. No. 60/723,021, filed Oct. 1, 2005; this application is a continuation-in-part of co-pending U.S. patent application Ser. No. 11/425,990, which claims the benefit and priority of U.S. provisional patent application Ser. No. 60/731,180, filed Oct. 29, 2005; this application is a continuation-in-part of co-pending U.S. patent application Ser. No. 11/551,702, which claims the benefit and priority of U.S. provisional patent application Ser. No. 60/748,832 filed Dec. 10, 2005; this application is also continuation-in-part of co-pending U.S. patent application Ser. No. 11/427,325, which claims the benefit and priority of U.S. provisional patent application Ser. No. 60/742,625, filed Dec. 05, 2005; this application also claims benefit and priority to U.S. provisional patent applications Ser. Nos. (a) 60/928,729, filed May 10, 2007, (b) 60/906,606, filed Mar. 12, 2007, (c) 60/918,772, filed Mar. 17, 2007, (d) 60/922,837, filed Apr. 10, 2007, (e) 60/925,038, filed Apr. 14, 2007, and (f) 60/925,489, filed Apr. 20, 2007; this application is also related to co-pending U.S. patent application Ser. No. 11/422,065, which claims the benefit and priority of U.S. provisional patent application Ser. No. 60/691,692 filed Jun. 16, 2005. The disclosures of all of the aforementioned applications are hereby incorporated by reference in their entirety.

### FIELD OF THE APPLICATION

The present invention relates to a user tracking and messaging service.

### BACKGROUND

Co-pending patent application Ser. No. 11/383,197, filed May 12, 2006 and which draws benefit and priority to provisional application Ser. No. 60/723,021, filed Oct. 1, 2005, the disclosure of both of which are incorporated herein by reference disclose methods, systems, and apparatus for enabling a centralized establishment-based patron tracking and messaging server that monitor of the presence of particular users, each indexed by a unique User identifier (“ID”), within each of a plurality of localized physical establishments, each indexed by unique Establishment ID. More specifically, the aforementioned patent applications disclose a plurality of embodiments in which a centralized establishment-based patron tracking and messaging server “receives a unique ID for each user who is currently patronizing each of a plurality of establishments along with a unique ID that identifies which establishment each user is patronizing.” In some embodiments, the server also maintains data about each user “that reflect their visiting behavior with respect to particular location-based establishments. Visiting behavior data includes, for example, an indication of which location-based establishments have been visited by the particular user and the frequency and/or number of times the user has visited each location based establishment.” In some such embodiments, an Establishment User List is maintained by the central server for each of a plurality of establishments, each Establishment User List including a unique ID for each of the users “who are currently determined to be patronizing the particular establishment.” In certain embodiments disclosed in the aforementioned patent applications, each user is associated with a unique User ID that is communicated from a portable computing device of that user, for example that user's mobile phone, to the central server when that user enters and/or is located within a particular establishment. In addition, each establishment is assigned a unique identifier referred to as an Establishment ID that is also communicated to the server “to identify which establishment a particular user is patronizing.” In addition, certain embodiments of the aforementioned patent applications enable establishment-specific information about each indexed establishment to be stored in an Establishment Database accessible to the central server, where the establishment-specific information includes “descriptive information, service information, current demographic profile information” relating to the indexed establishment. In addition, certain embodiments of the aforementioned patent applications enable establishment-specific messages to be conveyed back a particular user, relating to the particular establishment he or she is patronizing, in response to the receipt of a unique Establishment ID from a portable computing device of that particular user. In some such embodiments, the establishment-specific messages conveyed back to users include information accessed from the Establishment Database. In some embodiments, the server “also maintains and/or has access to a Personal Profile Database which contains personal demographic characteristics about each user indexed by unique ID.” In some such embodiments, the establishment-specific messages conveyed back to users include information accessed from the Personal Profile Database, relating to one or more users present within the particular establishment.

Thus, the aforementioned patent applications disclose a plurality of methods, systems and apparatus that are operative to enable a novel establishment-based tracking and messaging service that is moderated by a centralized patron tracking server, with the tracking server operative to monitor of the presence of particular users, each indexed by a unique User ID, within each of a plurality of particular localized physical establishments, each indexed by unique Establishment ID. The server also enables the passing of establishment-specific messages to and from patrons of those establishments based at least in part upon their presumed presence within a particular establishment. The methods, apparatus, and computer program products thus follow a “tell us you're here” patron tracking methodology in which electronic messages are sent to the centralized patron tracking server indicating the presence of a particular individual user (indexed by unique User ID) within a particular physical establishment (indexed by unique Establishment ID). Such messages, referred to herein as “attendance messages” comprise an electronic message that is sent to the centralized patron tracking server that contains a unique Establishment ID of a unique localized physical establishment and an indication as to which user is being identified as being currently present within the establishment. Based up the receipt of a plurality of such attendance messages, the central server stores in memory an indication of the presumed presence of a plurality of particular users within each of a plurality of particular establishments. Such a datastore of presumed customer presence within each of a plurality of localized physical establishments is referred to herein as an establishment attendance database. An establishment attendance database may be comprised of an Establishment User List for each of a plurality of establishments, thereby documenting which of a plurality of active users are present within each of a plurality of participating establishments.

The aforementioned patent applications also disclose methods, systems and apparatus that enable a user to send an “attendance message” indicating his or her presence within a particular localized physical establishment by interacting manually with a mobile computing device on his or her person. More specifically, a user may employ a messaging function of a mobile computing device on his or her person in which “the user sends an encoded messages such as a text message indicating that the user has either entered or exited a particular location-based establishment.” The message typically includes “a representation of the location-based establishment's unique establishment ID.” Thus, a particular user may, for example, send a text message to the central server, the text message including a unique establishment ID for an establishment that he or she has just entered, as a way of conveying an attendance message with respect to that particular establishment. The central server receives the message, parses the establishment ID from the message, and in response adds the particular user to the Establishment User List for the particular establishment (i.e., updates the establishment attendance database to reflect the fact that the particular user is believed to be present within the particular establishment). In some embodiments of the aforementioned patent applications, the text message sent from the portable computing device of the particular user may also include a flag or other indicator indicating if the user has “entered, exited, or is currently at or within the referenced establishment.” In this way a user may inform the central server as to his or her arrival, departure, or presence within a particular localized physical establishment by sending an electronic message such as, for example, a Short Messaging Service (“SMS”) text message to the centralized establishment server, with the message referencing the unique establishment ID of the particular establishment.

In some embodiments of these patent applications, the text message sent from the portable computing device of the particular user may also include the unique user ID of the user encoded within the message. In other embodiments the unique user ID of the user is accessed and/or referenced in relation to the unique electronic address of the portable computing device of the user. In some embodiments an attendance message is automatically sent from the portable computing device of a user to the establishment-based patron tracking server in response to a triggered RFID tag. In other embodiments the attendance message an attendance message is automatically sent and/or received in response to other sensor readings and/or other detected signals.

As disclosed by the present inventor in co-pending patent application Ser. No. 11/422,065, filed Jun. 2, 2006, and which draws priority to provisional application serial No. 60/723,021, filed Jun. 2, 2005, both of which are incorporated herein by reference, additional methods, systems, and apparatus are disclosed for enabling customer interactions within restaurant-type establishments. As disclosed in the aforementioned patent applications, the user may send a message from his or her portable computing device to a server process, the message indicating a unique seating location of the user within the establishment, referenced through a unique seating location ID. In this way a server process may keep track of where within the establishment the user is seated. In some such embodiments, the seating location of the user is conveyed from a portable computing device of the user, such as the user's PDA or mobile phone, as a result of the user entering seating identification data entered into his or her portable computing device and conveying the seating identification data as an electronic message to the server process. In some embodiments, the seating location of the user is captured by a sensor of the portable computing device. In some such embodiments the location data is detected by an RFID sensor of the portable computing device. In other embodiments the location data is detected by a digital camera of the portable computing device. In some such embodiments, optical image recognition software is employed to determine the location data for the user, for example the table identification value and/or seat identification values associated with a user's seating location within the establishment. In some such embodiments, one or more unique graphic and/or text representations is affixed to and/or inscribed upon the table that encode a particular table identification value and/or seat identification value such that when it is captured by said digital camera and processed with said image recognition software, the unique seating location of the user with a particular establishment is received by the portable computing device. In addition the aforementioned patent discloses methods by which patrons of an establishment may receive establishment-specific information and/or make establishment-specific requests that are seating-location specific.

### SUMMARY

Embodiments of the present invention are directed to methods, systems, and apparatus for enabling a centralized establishment-based patron tracking and messaging server. The server is configured to monitor of the attendance of particular users, each indexed by a unique User ID, within each of a plurality of localized physical establishments, each indexed by unique Establishment ID. More specifically, the centralized establishment-based patron tracking and messaging server is configured to receive electronic attendance messages from the portable computing devices of each of a plurality of users who are currently patronizing each of a plurality of establishments, where each attendance message indicates that a particular user is currently present within a particular establishment. In a common embodiment the portable computing devices are mobile phones of users and the electronic attendance messages are SMS text messages sent from the mobile phones of each user to the centralized server. The SMS messages include an encoded indication of the Establishment ID of the establishment that the sending user is currently patronizing. In response to receiving such messages, the centralized establishment-based patron tracking and messaging server maintains a data store, referred to herein as an establishment attendance database. The data store indicates which of a plurality of individual users are believed to be currently in attendance within which of a plurality of individual physical establishments.

By using such a database, embodiments of the present invention are operative to enable establishment-specific messages to be sent to and from the portable computing devices of particular users based at least in part upon the particular establishment the users are documented as patronizing. In some embodiments the establishment-specific messages sent to the portable computing devices of users who are currently patronizing particular establishments. In some embodiments the establishment-specific messages are sent to the portable computing devices of users who have previously patronized particular establishments. In some embodiments the establishment-specific messages are establishment-specific promotional offers redeemable for free or discounted products or services of the establishment to which it relates. Embodiments of the present invention are also operative to enable establishment-specific services to be requested and/or delivered to and/or from particular users based at least in part upon the particular establishment that the particular user is documented as patronizing. In some embodiments a time-out period is defined for each establishment. The time-out period indicates how long after a last attendance message is received relating to the particular establishment that the user is documented as patronizing the particular establishment. In some such embodiments the promotional offers are time-limited, and are valid for redemption within the particular establishment within a defined time period following receipt by the portable computing device of a particular user.

In some embodiments of the present invention, a particular user is documented in the establishment attendance database as being present within a particular localized physical establishment for an extended period of time following the receipt of an attendance message relating to that particular localized physical establishment. The extended period of time is the shortest of (a) until the time-out period of that particular establishment has elapsed following the receipt of the attendance message, (b) until a new attendance message has been received indicating that the particular user is now present within a different localized physical establishment, or (c) until an exit message is received indicating that the user has specifically exited the particular localized physical establishment. In this way the routines of the present invention may be configured to presume a particular user as being present within a particular establishment for an extended period of time following a received attendance message indicating that the particular user is present within the particular establishment, the extended period of time ending upon the first of an expired time-out period, the receipt of a new attendance message indicating that the particular user is now present within a different particular establishment, and the receipt of an exit message indicating that the user has exited the particular establishment.

In addition, embodiments of the present invention may be configured to enable patron-to-patron messaging to be performed with message delivery being dependent, at least in part, upon patron presence within a particular localized physical establishment. In addition, embodiments of the present invention may be configured to enable personal-reminder messages to be sent by patrons to themselves. The delivery is dependent, at least in part, upon presence within a particular localized physical establishment. Embodiments of the present invention may also be configured to enable the user to request establishment-specific services by sending messages to the centralized server, the establishment-specific services being relationally associated with the particular establishment that the user is currently documented as being present within.

Embodiments of the present invention may also be configured to enable a user to request patronage information from the centralized server relating to a particular establishment, where the patronage information indicates the current customer makeup of that establishment as documented in the establishment attendance database. In some embodiments a user may request a patronage profile of a particular establishment. The patronage profile comprises an indication of the current patronage makeup of the identified establishment. The patronage profile is returned as an electronic message from the centralized establishment-based patron tracking and messaging server to the portable computing device of the user. In some embodiments the patronage profile may comprise a numerical indication of the number of documented patrons and/or a statistical indication of the demographic makeup the documented patrons. In some embodiments the Patronage Profile may also include a listing of the names and/or other unique identifiers of current patrons of the identified establishment who are documented as being friends of the requesting user in an accessible database. In some embodiments the Patronage Profile further includes a listing of the names and/or other unique identifiers of current patrons of the identified establishment who are documented in an accessible database as being affiliated with a particular school, team, club, or organization.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates an establishment-based patron tracking and messaging application running on a server or a group of servers according to an embodiment of the invention;

FIG. 2A illustrates a portable computing device configured with hardware and software according to an embodiment of the invention;

FIG. 2B illustrates a message sent to a patron of an establishment based upon current patronage data according to an embodiment of the invention;

FIG. 3 illustrates a flowchart of an example process that supports the maintaining of the Establishment Attendance Database based upon received Attendance Messages and tracking of attendance time_outs for particular establishments according to an embodiment of the invention;

FIG. 4 illustrates an example resulting display screen is for such an electronic message display according to an embodiment of the invention; and

FIG. 5 illustrates a portable computing device configured with appropriate hardware and software to support the establishment-based patronage profiling features disclosed herein according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention are directed to methods, systems, and apparatus for enabling a centralized establishment-based patron tracking and messaging server that monitors the attendance of particular users, each indexed by a unique User ID, within each of a plurality of localized physical establishments, each indexed by unique Establishment ID. More specifically, the centralized server is configured to receive electronic attendance messages from a portable computing device of each of a plurality of users who are currently patronizing each of a plurality of establishments, each attendance message indicating that a particular user is currently present within a particular establishment. In response to receiving such attendance messages, the centralized establishment-based patron tracking and messaging server maintains a data store indicative of which of a plurality of individual users are believed to be currently present within which of a plurality of individual physical establishments. Using such a data store, embodiments of the present invention are operative to enable establishment-specific messages to be sent to and from the portable computing devices of particular users based at least in part upon the particular establishment the users are documented as patronizing. In addition, by using such a data store, embodiments of the present invention are operative to enable establishment-specific services to be requested and/or delivered based at least in part upon the particular establishment the users are documented as patronizing. In some embodiments a time-out period is defined for each establishment. The time-out period indicates how long after a last attendance message is received that the user is documented as patronizing the indicated establishment. The establishment-specific messages may be sent to the portable computing devices of particular users based on the establishments the users are documented as patronizing, and may be promotional offers for free or discounted products or services of the establishment. In some embodiments, the promotional offers are time-limited, meaning that they are only redeemable within the establishment for a predetermined time period following the sending and/or receipt of the electronic establishment-specific promotional offer.

An establishment-based patron tracking and messaging (“EBPTM”) service is disclosed herein that is moderated by a centralized server. The centralized server is operative to document the presumed current presence of a plurality of individual users, each indexed by a unique User ID, within each of a plurality of localized physical establishments, each of which are indexed by unique Establishment ID. The EBPTM server also enables the passing of establishment-specific messages to and from the portable computing devices of users at least in part upon their documented presence within particular physical establishments. The EBPTM server also enables users to request of establishment-specific services by sending service requests from personal portable computing devices on their person, to the centralized server. The service requests are relationally associated with the establishment that the requesting user is documented as being currently present within. In certain preferred embodiments, a user sends an electronic message from a portable computing device on his or her person, to the EBPTM server. The electronic message indicates his or her current presence within a particular localized physical establishment. In some such embodiments, the electronic message is an SMS text message that includes the unique Establishment ID of the particular localized physical establishment that the user is currently patronizing. Thus, a user may enter a particular physical establishment, for example, and send a quick text message to the EBPTM server, where the text message including the unique Establishment ID of the particular establishment. The EBPTM receives the message, parses it, and in response documents the user's presence within the particular establishment. Once documented, the user's presence within that establishment is used by the EBPTM server to facilitate establishment-specific message passing processes and/or establishment-specific service request processes. The EBPTM server may also use the documented presence of particular user's within particular establishments to facilitate person-to-person establishment-based messaging and/or establishment-based reminder messaging.

In these ways, the methods, apparatus, and computer program products disclosed herein follow a “tell us you're here” patron tracking methodology in which electronic messages are sent to the EBPTM server indicating the presence of particular individual users (each indexed by unique User ID) within particular physical establishments (each indexed by unique Establishment ID). Each of such messages is referred to herein as an “attendance message” and comprises an electronic message sent to the centralized EBPTM server containing a unique Establishment ID of a unique localized physical establishment and an indication as to which user is being identified as being currently present within the establishment. Based up the receipt of a plurality of such attendance messages, the central server stores an in memory an indication of the presumed presence of a plurality of particular users within each of a plurality of particular establishments. Such a data store of presumed customer presence within each of a plurality of localized physical establishments is referred to herein as an “Establishment Attendance Database.”

In some embodiments a time-out period is defined for each establishment. The time-out period indicates how long after a last attendance message is received relating to the particular establishment that the user is documented as currently patronizing the particular establishment within the Establishment Attendance Database. In some such embodiments, a particular user is documented in the Establishment Attendance Database as being present within a particular localized physical establishment for an extended period of time following the receipt of an attendance message relating to that particular localized physical establishment. The extended period of time is the shortest of (a) until the time-out period of that particular establishment has elapsed following the receipt of the attendance message, (b) until a new attendance message has been received indicating that the particular user is now present within a different localized physical establishment, or (c) until an exit message is received indicating that the user has specifically exited the particular localized physical establishment. In this way the routines of the present invention may be configured to document a particular user as being present within a particular establishment for an extended period of time following a received attendance message indicating that the particular user is present within the particular establishment. The extended period of time ends upon the first of (a) an expired time-out period, (b) the receipt of a new attendance message indicating that the particular user is now present within a different particular establishment, and (c) the receipt of an exit message indicating that the user has exited the particular establishment.

The Establishment Attendance Database may also include historical data indicating the patronage history of particular users with respect to particular establishment, documenting, for example, which establishments have been visited by which users, when the visits happened, and how long the visits lasted. The portion of the establishment attendance database that documents the current patrons who are believe to be present within a particular establishment is referred to herein as the “Establishment User List” for the particular establishment at a particular moment in time. The portion of the establishment attendance database that documents previous patrons of a particular establishment over a period of time is referred to herein as the “Establishment Patronage History” for the particular establishment.

The portion of the establishment attendance database that documents, for each of a plurality of particular users, the localized physical establishments that the user has been documented as visiting over a period of time is referred to as the “User Patronage History” for that particular user.

An Establishment Information Database may be maintained accessible to the EBPTM server. The Establishment Information Database contains establishment-specific information including “descriptive information, service information, current demographic profile information” relating to each of a plurality of indexed establishments. Thus, the Establishment Information Database may comprise product information, menu information, promotional offer information, promotional message information, and/or service information, relating to that particular establishment, and indexed with respect to the unique Establishment ID of that particular establishment.

The EBPTM server also maintains user data about each of a plurality of individual users of the Establishment-Based Patron Tracking and Messaging Service. The user data includes personal profile information and customer account data. The personal profile information generally includes demographic characteristics for each of the plurality of individual users such as that user's age, gender, highest level of schooling, marital status, political affiliations, school affiliations, team affiliations, club affiliations, organizational affiliations, hobbies, interests, profession, job title and/or hierarchy level within an organization, sexual orientation, annual income, sporting team preferences, status as a tourist or resident within the current geographic region, relationship status (i.e., whether in a relationship or looking for a relationship), musical preferences, IQ, entertainment preferences, food and drink preferences, clothing preferences, brand preferences, and/or other similar personal characteristics. The personal profile information may also include user body height information, user body weight information, user pants size information, user shirt size information, and/or user shoe size information. More specifically, the EBPTM server, as disclosed herein, may be configured to maintain and/or access a database of personal profile information for each of a plurality of users, the personal profile information for each user being referenced by a unique user ID or other unique identifier for each user by which the information for that user is indexed. Such a database is referred to herein as a “Personal Profile Database.” In addition, customer account data may be stored for each user reflecting a number of credits and/or a billing balance assigned to the user.

By using the relational associations between users and establishments as stored within the Establishment Attendance Database, embodiments of the present invention are operative to enable establishment-specific messages to be sent to and from the portable computing devices of particular users based at least in part upon the particular establishment the users are documented as patronizing. In some embodiments the establishment-specific messages are sent to the portable computing devices of users who are currently patronizing particular establishments. In some embodiments the establishment-specific messages are sent to the portable computing devices of users who have previously patronized particular establishments. In some embodiments the establishment-specific messages are sent to the portable computing devices of users based upon a combination of (a) the establishment they are documented as currently patronizing and (b) historical data indicating previous patronage by the user of one or more establishments. In this way, for example, a current customer of an establishment may be messaged, directly to a portable computing device on his or her person, with a message relating to a particular establishment, based at least in part upon his or her current patronage of the establishment as well as historical data about his or her pervious patronage of the establishment. In one example embodiment, a user is sent a message relating to a particular establishment based at least in part upon the fact that (a) he is currently documented as being within the establishment, and (b) he is historically documented as having visited the establishment more than five times in the last 12 months. Thus, embodiments of the present invention enable establishment-specific messages to be sent to particular patrons of establishments in a highly targeted and customized manner.

In some embodiments the establishment-specific promotional messages sent to users relating to a particular physical establishment are accessed from the Establishment Information Database by indexing the unique Establishment ID of the particular establishment. The portion of the Establishment Information Database containing promotional messages and/or offers is referred to herein as the “Promotional Messaging Database.” The promotional messaging database may contain a plurality of establishment-specific promotional messages associated with each of a plurality of physical establishments.

In some embodiments the establishment-specific promotional messages sent to the portable computing devices of current and/or past patrons of particular establishments are establishment-specific promotional offers. The promotional offers are redeemable for free or discounted products or services of the particular establishment to which it relates. For example, an establishment specific promotional offer relating to a particular restaurant establishment may comprise an offer for a free appetizer, drink, entree, or desert within that establishment. In some such embodiments the promotional offers are time-limited such that they are only valid for redemption within the particular establishment within a defined time period following receipt by the portable computing device of a particular user. For example, in an example embodiment an establishment-specific promotional offer may be relationally associated with a time-limit such that it is only redeemable for a period of 45 minutes after the message is conveyed to the portable computing device of a particular user. In this way the user who receives the message is motivated to act quickly upon the promotional message to redeem its value. In an example scenario, an establishment-specific promotional message sent to a user is a time-limited promotional offer, the time-limited promotional offer being sent to a previous patron of a particular restaurant. The time-limited promotional offer may comprise, for example, an offer for a free appetizer, redeemable within the next 45 minutes. In this way a previous patron of a particular establishment may receive a real-time message directly upon his or her portable computing device (e.g., mobile phone), indicating that if he or she arrives within the particular establishment within the next 45 minutes, he or she can receive a free appetizer. Such a promotional offer thus has the ability to motive the receiving patron to visit the particular establishment in a timely manner. In his way the EBPTM server provides the establishment with a service such that it may request the transmission of real time promotional messages, that are time-limited and thus time motivating, to previous patrons of that establishment, directly to the mobile phones or other portable computing devices of those patrons, based at least in part upon the stored patronage history in the Establishment Attendance Database.

Embodiments are also operative to enable establishment-specific services to be requested and/or delivered to and/or from particular users based at least in part upon the particular establishment the particular user is documented as patronizing within the Establishment Attendance Database. For example, a patron of an establishment may request a menu from the EBPTM server. Because the EBPTM server maintains data documenting what establishment the user is currently patronizing, each indexed by unique user ID, the EBPTM server may access a menu for the particular establishment the user is currently patronizing from the Establishment Information Database, indexing that database with the Establishment ID of the establishment that the user is documented as currently patronizing. This enables a centralized service to maintain establishment-specific informational messages for a large number of different establishments and distribute the informational messages to users based upon attendance messages that identify which establishment a particular user is patronizing. In this way, a user may enter an establishment, send an Attendance Message to the EBPTM server indicating that he or she is currently present within the particular establishment (by conveying the unique Establishment ID for that establishment) and receive an establishment-specific message relating to that establishment. The EBPTM serve then maintains a record of that particular user (indexed by unique User ID) as being present within that particular establishment (indexed by unique Establishment ID). Then, at a later time, but before the time-out period has expired, that particular user may send a “menu request” message to the EBPTM server. The user need not re-identify a particular establishment because the user has already informed the EBPTM server as to his or her current patronage.

Thus, the user may simply send a generic “menu request” message to the EBPTM server, the server accessing the Establishment Attendance Database and access a record for the requesting user indicating the unique Establishment ID of the establishment he is currently patronizing. The EBPTM server then accesses the Establishment Information Database, using that unique Establishment ID, retrieves the menu for that particular establishment, and returns it as an electronic message to the requesting patron. In this way the patron was able to request a menu, as he would be able to request other information and/or services, relating to the particular establishment, without needing to re-identify the establishment. This is a substantial value of the “tell us you're here” methodology wherein the EBPTM server maintaining a data store documenting the current patronage of a plurality of users, indexed by unique user ID and unique establishment ID. Additional establishment-specific information requests and/or service requests are disclosed in the plurality of co-pending patents incorporated herein by reference. Most such services can benefit from the patronage tracking database described herein, reducing the amount of information that need be exchanged between patrons and the central server.

In addition, embodiments of the present invention may be configured to enable person-to-person messaging to be performed with message delivery being dependent, at least in part, upon the documented presence of the receiving patron within a particular localized physical establishment. In such embodiments a message may be sent from a computing device of a first user to a portable computing device of a second user, with the message being addressed with a unique electronic address of the second user and with a unique establishment ID (or group of establishment ID's) that define the location(s) for which the second user must be believed to be present for the electronic message to be delivered. In this way, a first user may send a message to a second user, for example, by texting a message to the phone number of the second user and to the Establishment ID of a particular coffeehouse where the second patron visits. The EBPTM server holds the message in memory, and delivers it to the portable computing device of the second user the next time the server receives an Attendance Message indicating that the second user is present within the particular coffeehouse. This creates a fun process in which users may send electronic messages to other users, link the messages to specific establishments (e.g., restaurants, coffeehouses, retail stores, bars, or theaters), such that the messages delivered dependent upon determinations of establishment-specific presence of the second user within the related establishment(s). A more detailed disclosure of person-to-person establishment-based messaging is described in co-pending provisional application Ser. No. 60/925,038, filed date is Apr. 14, 2007, the disclosure of which is incorporated herein by reference in its entirely.

In addition, embodiments of the present invention may be configured to enable personal reminder messaging in which a user composes a reminder message for himself or herself, where the reminder messages being delivered and/or displayed to the user are dependent, at least in part, upon the documented arrival and/or presence of the user within a particular localized physical establishment. In such embodiments, a reminder message may be stored accessible to the EBPTM server, relationally associated with a unique establishment ID (or group of establishment ID's) that define the location(s) for which the user must be believed present for the reminder message to be delivered. The EBPTM server holds the message in memory, delivering it to the portable computing device of the user the next time the server receives an Attendance Message indicating that the user is present within an establishment relationally associated with the reminder message. This creates a useful process in which users may compose and send reminder messages to themselves, link the messages to specific establishments (e.g., restaurants, coffeehouses, retail stores, bars, or theaters), such that the messages are automatically delivered by a process of the EBPTM server dependent upon determinations of establishment-specific presence of the user within the related establishment(s). A more detailed disclosure of establishment-based reminder messaging is described in co-pending patent applications by the present inventor, including application Ser. No. 11/551,720, the disclosure of which is incorporated herein by reference in its entirely.

In some such embodiments a user may request information indicating whether any friends and/or acquaintances are currently documented as being present within a particular localized physical establishment by sending a patronage profile request to the EBPTM server relating to a particular localized physical establishment. In general, the user sends a patronage profile request to the EBPTM server. The request includes the unique establishment ID of the establishment for which the user desires current patronage profile information. The current patronage profile information that is returned to the computing device of the user by the EBPTM server may be numerical, for example, including an indication of the number of friends and/or acquaintances present within the establishment, or may include a listing of unique identifiers for each friend or acquaintance that is currently present within the establishment. In one embodiment that supports such features, the Personal Profile Information stored for each user includes a Friends List that indicates a plurality of other users, by unique ID of each, that the profiled user considers friends. Thus, when that user sends a patronage profile request to the EBPTM server, the server accesses the Establishment User List for that establishment, accesses the Friends List for that user, and determines whether any of the users who are listed on the Friends List for that user, are currently present on the Establishment User List for that establishment. If so, the EBPTM server returns a message to the computing device of the requesting user, informing the requesting user as to the number or percentage of friends who are present within the identified establishment and/or returns a message with a listing of the friends, by name or handle or unique ID, who are present within the identified establishment. In this way, a user may send a patronage profile request to the EBPTM server, including the unique Establishment ID of a particular coffeehouse, and be returned an electronic message that includes a listing of any friends of that user who are currently present within that coffeehouse. The user may also request statistical information about the current patronage of the identified establishment, for example the total number of patrons currently present, the percentage of patrons who are a particular gender, the percentage of patrons who are single, and/or the percentage of patrons who are of a particular age group, and/or the percentage of patrons who are identified as being members of a particular club, group, team, or school. More detailed explanations of establishment-based patronage profiling are described in co-pending patent applications by the present inventor, including application Ser. No. 11/383,197 and provisional application Ser. Nos. 60/723,021 and 60/918,772, all of which are incorporated herein by reference in their entirely.

In many preferred embodiments, the portable computing devices of users are mobile telephones of the individual users and the electronic messages are SMS text messages. In some such embodiments, an individual user sends a text message from his or her mobile phone, to the EBPTM server, the SMS text message including within the content a representation of the unique Establishment ID of the particular establishment that the user has just arrived in and/or is currently present within. Thus, embodiments of the present invention enable an individual user, upon arrival within a localized physical establishment, to type into his or her mobile phone the unique Establishment ID of the physical establishment and send it as a text message to the patron tracking server, thereby informing the server that the particular user is now currently present within the particular establishment. Thus, the user has performed the “tell us you're here” process, informing the server that he or she is “here” (i.e., physically present) within the localized physical establishment that is relationally associated with the unique Establishment ID. The unique identity of the particular user is determined either by a unique user ID that is included within the content of the SMS text message and/or by a unique electronic address of the portable computing device from which the message was received. In this way the establishment-based patron tracking server is operative to receive “tell us you're here” messages from each of a plurality of individual users, each “tell us you're here” message indicating the presence of a particular user within a particular localized physical establishment. The establishment-based server is then operative, based upon such received messages, to maintain an Establishment Attendance Database of patron tracking information, the database documenting the presumed presence of each of a plurality of individual users within each of a plurality of particular localized physical establishment.

In some such embodiments, the users are informed of the unique Establishment ID of an establishment based upon visually posted signs and/or placards within the establishment. For example, a sticker upon the door of the establishment is posted that includes the unique Establishment ID of that establishment. The ID may include a unique identifying mark or symbol such that a user can easily recognize it as an Establishment ID. In some such embodiments the unique symbol is a leading and trailing pound sign, such that a sticker with the symbol #104324# would be easily identified by a user as an Establishment ID sticker for the establishment, the Establishment ID being the unique value 104324. Thus a user, upon viewing the sticker or other similar visual display within the establishment, may type in the value 104324 into his or her mobile phone, may text message it to the EBPTM server, and may thereby send an Attendance Message to the server indicating his or her arrival and/or presence within the particular establishment. This is a fast and easy process. In other embodiments the Establishment ID may be conveyed electronically to the portable computing device of a user upon arrival and/or during presence within a particular establishment. Similar to the processes disclosed in co-pending patent applications Ser. Nos. 11/383,197 and 11/422,065, the unique ID may be alternately conveyed for example, by RFID scanner, bar code scanner, digital camera, and/or other localized informational scanning and/or transmission technology. For example, the establishment ID of a particular establishment may be encoded as a unique graphic that is posted within the establishment upon a door or wall or table. The unique graphic may be selectively captured by a digital camera of a user's portable computing device and processed to automatically determine the unique establishment ID value. In this way a patron may receive the unique establishment ID by just clicking a picture of the unique graphic within an establishment with his portable computing device.

In addition, some embodiments enable individual users to also send a unique Seating Location ID to the EBPTM server, indicating a unique seating location of the particular user within the particular establishment within which they are currently present. The establishment-based patron tracking server may then store within the Establishment Attendance Database, an indication of which seating locations, individual patrons are located within, when present within a particular establishment. Such methods are useful for establishments that have unique tables, seats, or other fixed seating locations.

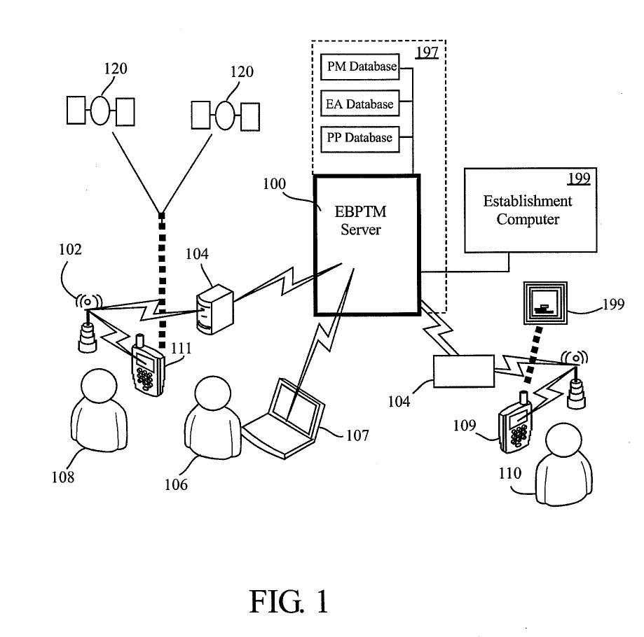

FIG. 1 illustrates an establishment-based patron tracking and messaging application (i.e., EBPTM application) running on a server or a group of servers (i.e., EBPTM server) according to an embodiment of the invention. An example EBPTM server running EBPTM software is shown as element 100. As described previously, the server may access one or more data stores that include a plurality of databases 197. The databases include an Establishment Attendance Database (EA Database), a Personal Profile Database (PP Database) and a Promotional Messaging Database (PM Database). Additional databases (not shown) may also be included including a person-to-person messaging database and/or a personal reminder database, both of which may store a plurality of messages that are addressed to users based upon unique electronic address of their portable computing devices AND based upon one or more localized physical establishments that they may visit in the future.

By maintaining the aforementioned Establishment Attendance Database in data store 197, the EBPTM application is operative to keep track of the patronage of each of a plurality of location-based establishments (not shown) by each of a plurality of patrons (108, 106, 110). As represented in FIG. 1, the EBPTM software application is operative to give a plurality of users (for example user 106, 108, 110), each using a portable computing device (107, 109, 111), the ability to inform the EBPTM server as to their arrival and/or presence within a particular localized physical establishment as well as the ability receive establishment-specific messages and/or request establishment-specific services. As described above, a user (106, 108, 110) may use his or her portable computing device (111, 107, 109) to send an Attendance Message to the EBPTM server 100, the attendance message including the unique establishment ID of the establishment that he or she has arrived in and/or is present within. The EBPTM server 100 parses the Attendance Message, extracting data from the content of the message and/or the electronic address of the sending portable computing device. In this way the EBPTM server 100 determines from the Attendance Message, which user (by unique user ID) is present within which establishment (by unique Establishment ID). An indication of this patronage is stored within the Establishment Attendance Database, optionally along with a time stamp for when the Attendance Message was received by the EBPTM server 100.

Each enabled portable computing device may run EBPTM client software that enables information exchange to and from the EBPTM server 100 over a communication link, for example communication link 114 or through a gateway 104 to a mobile service provider. In some embodiments, standard SMS text messaging protocols are used via manual user input, avoiding the need for custom EBPTM client software. In other embodiments SMS text messaging protocols are used under the control of a custom software application running upon the portable computing device. In some embodiments of the present invention, mobile computing device (107, 109, and 111) has access to locative data such as GPS data used for determining a current spatial location of the mobile computing device. GPS data is generally derived by a transceiver on board the mobile computing device that references orbiting satellites 120. In some embodiments a lookup table may be used to relate GPS locations to particular spatial boundaries that correspond to a particular localized physical establishment associated with a particular Establishment ID value. In some embodiments of the present invention, mobile computing device (107, 109, and 111) may access Establishment ID values electronically, for example using an RFID scanner that accesses an RFID chip 199 and reads Establishment ID information from the chip. In such embodiments the chip may be located in a doorway of the establishment and is automatically accessed upon entry by the user.

Thus as illustrated in FIG. 1, the present invention may be implemented as a managed service (e.g., in an ASP model) using an EBPTM server 100, which is connected or connectable to one or more networks. For illustrated purposes, the EBPTM server 100 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described herein. In a typical implementation, the service comprises a set of one or more computers. A representative machine is a network-based server running commodity (e.g., Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a corporate intranet, a private network, or any combination thereof, depending on the desired implementation environment. As illustrated FIG. 1, the EBPTM server 100 is also in communication with a mobile service provider (MSP) 102 through a gateway, such as SMS gateway 104. In this way portable computing devices may communicate with the EBPTM server 100 via cellular networks, internet communication pathways, and/or SMS messaging pathways. In a preferred embodiment, SMS messaging is used because of its widespread usage on mobile phones.

As also illustrated in FIG. 1, one or more users 106 register for the service, typically by using a client machine which may be the portable computing device 111 or some other machines such as a personal portable computer 107. The registration process may include a user entering personal demographic data about themselves, for example their age, gender, marital status, organizational affiliations, school affiliations, musical tastes, food tastes, height, weight, shirt size, pants size, shoe size, listing of friends, favorite colors, and/or favorite product brands.

As also illustrated in FIG. 1, each establishment that participates in the EBPTM service may have one or more Establishment Computers 199 that is in communication with the EBPTM server 100. The Establishment Computer 199 may be used by employees of the establishment to configure settings, define and/or select establishment-specific promotional messages that are stored in the PM database, define and/or select the messaging rules by which the EBPTM server 100 sends promotional messages to current and/or past patrons of the establishment, and/or to check the patronage profile of current and/or past patrons by accessing demographic statistics for the establishment. The Establishment Computer 199 may also be used to convey service requests from patrons of the establishment to employees of the establishment, the service requests being displayed upon a screen of the Establishment Computer 199 such that they may be viewed by employees of the establishment. In this way the EBPTM server 100 enables a unique form of communication, both through messaging and service requests, between establishments and patrons of those establishments. Additional information about the intelligent routing of service requests directly to personal computing devices of particular establishment employees is disclosed in co-pending patent application Ser. No. 11/422,065 which is incorporated herein by reference in its entirety.

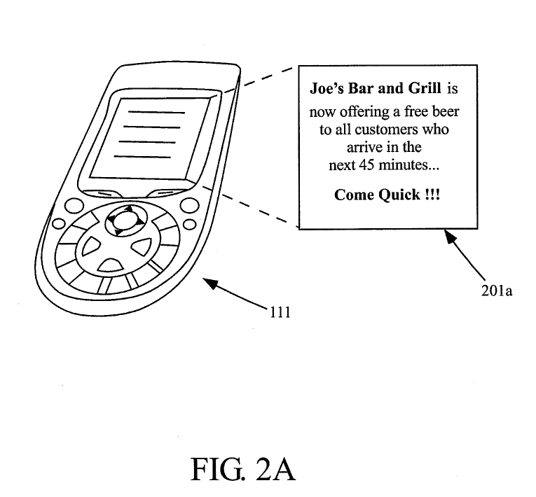

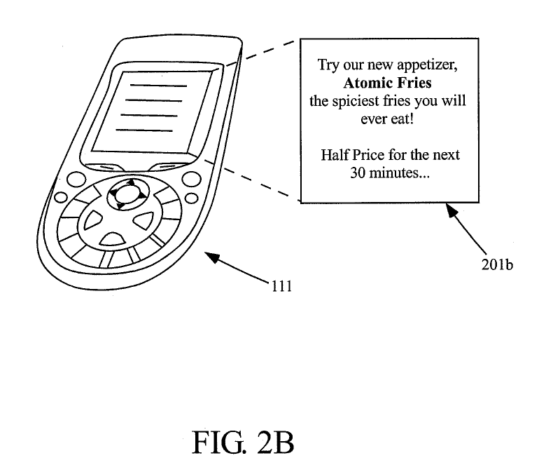

FIG. 2A illustrates a portable computing device 111 configured with hardware and software according to an embodiment of the invention. As shown, the computing device may take the form of a handheld device such as a cell phone or PDA and includes display functionality and user interface controls. Such a portable computing device is operative to exchange information with the EBPTM server 100 over a communication link. The communication link may take any common form such as, for example, a wireless communication link to an information network such as the Internet. The portable computing device may also include a differential GPS transceiver for sensing the geographic location of the portable computing device with a high degree of accuracy. The portable computing device includes a user interface including display features and user input features. In typical embodiments a graphical user interface is enabled upon the display that allows users to enter information and/or make selections that is sent to the EBPTM server 100 as well as allows the user to view information received from the EBPTM server 100. In this way, the user may use the portable computing device to inform the EBPTM server 100 as to his or her presence within a particular localized physical establishment by causing an Attendance Message relating to the establishment to be sent to the EBPTM server 100. This may be performed by the user manually entering the establishment ID into the portable computing device and sending it as an SMS text message to the EBPTM server. In some embodiments the portable computing device 111 may be configured with a digital camera for use in capturing unique graphical identifiers from which an establishment ID, seating location ID, and/or table location ID may be automatically derived. The portable computing device 111 may also be configured with an RFID scanner from which an establishment ID, seating location ID, and/or table location ID may be electronically received. In such embodiments, once the establishment ID is captured by the portable computing device, it is sent to the EBPTM server as an Attendance Message, for example as an SMS text message.

In response to such Attendance Messages, the EBPTM server 100 may send establishment-specific messages back to the portable computing device of the user such as, for example, establishment-specific promotional messages and/or establishment-specific promotional offers. In some embodiments the establishment-specific promotional offers are redeemable by the user of the portable computing device for a free or discounted product or service of the establishment. In some such embodiments the promotional offer may include a password or code key that is used by the user of the portable computing device to redeem the value of the promotional offer within the particular establishment to which it relates. In some embodiments the establishment specific promotional offers are time-limited, being redeemable only for a defined period of time following the transmission and/or receipt of the promotional offer electronic message. In some such embodiments, the time-limitation period is a short period such as 45 minutes.

In response to receiving establishment-specific promotional messages from the EBPTM server 100, the portable computing device may be enabled to display the content of the messages to the user of the device. In this way the portable computing device enables the user to view establishment-specific promotional messages and/or promotional offers sent via the EBPTM server 100 to the user, relating to a particular localized physical establishment. In some embodiments, the user interface may enable a standard SMS text messaging protocol in which users send SMS text messages, including Attendance Messages and Service Request messages, to the EBPTM server 100 via manual text input and SMS messaging protocols. In addition, the portable computing device may receive SMS text messages from the EBPTM server 100 via standard messaging protocols, including promotional messages and/or promotional offers. Alternately, the user interface may include menus and/or forms through which a user can select a particular establishment or establishments that he or she is currently visiting. In some such embodiments, an EBPTM client application enables such menus and sends an electronic message to the EBPTM server 100 in response to user selections from the menus. In some such embodiments the electronic messages sent by the EBPTM client application in SMS text messaging form, automatically generated by the client application in response to the menu interactions of the user.

As used herein, “portable computing device,” is meant to be broadly construed as including any mobile wireless client device, e.g., a cell phone, pager, a personal digital assistant (PDA, e.g., with General Packet Radio Service (“GPRS”) Network Interface Card (“NIC”)), a mobile computer with a smartphone client, or the like. A typical portable computing device is a wireless access protocol (“WAP”)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including Cellular Digital Packet Data (“CDPD”), Code Division Multiple Access (“CDMA”), Global System for Mobile communications (“GSM”), Personal Digital Cellular (“PDC”), Personal Handy-phone System (“PHS”), Time Division Multiple Access (“TDMA”), FLEX, ReFLEX, Integrated Digital Enhanced Network (“iDEN”), TErrestrial Trunked RAdio (“TETRA”), Digital Enhanced Cordless Telecommunications (“DECT”), DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication networks) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (“EMS”), multi-media message (“MMS”), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. Embodiments of the present invention are not limited to mobile device users who have WAP-enabled devices or to use of any particular type of wireless network. Such devices and networks are merely illustrative; any wireless data communication technology now known or hereafter developed may be used in connection with the invention.

In some embodiments the attendance message is generated in response to user input with support from geospatial tracking technology. For example, if the portable computing device is equipped with GPS transducer capabilities, as described above, a database may be accessed that correlates certain geospatial locations, areas, boundaries, regions, and/or proximities, to certain commercial establishments such as restaurants, bars, coffeehouses, and/or retail stores. Such a database may include a lookup table that correlates particular geospatial regions, each defined by an area or boundary, to certain unique physical establishments, each with a unique Establishment ID. Based upon a current geospatial coordinate of the user, as determined for example by a GPS tracking sensor of the portable computing device of the user, a software process may determine if the user is currently within, or has just crossed into, a geospatial area or boundary that is associated with a particular establishment. If so, the database may be used to automatically access the unique Establishment ID of the establishment to which the user's current location is related. This Establishment ID may then be conveyed to the EBPTM process along with the unique user ID of the user of the portable computing device as part of an attendance message. In some such embodiments, the database that correlates particular geospatial regions with unique physical establishments may be directly accessible by the EBPTM server in response to received geospatial coordinates associated with the particular user. Additional details about how a particular geospatial area may be defined and associated with a particular physical establishment, as well as additional details about how a user of a particular portable computing device may be determined to be within a particular geospatial area associated with a particular establishment, is disclosed in co-pending U.S. patent application Ser. No. 11/427,325, which has been incorporated herein by reference in its entirety.

Because the establishment based tracking and messaging process described herein is generally initiated in response to a user selectively informing the EBPTM server that he or she is present within a particular establishment, a unique user interface may be employed wherein a user may selectively send an electronic attendance message to the EBPTM server from his or her portable computing device by interacting with a user interface of the portable computing device. The process may function as follows—a user enters a particular establishment with a portable computing device. The computing device automatically accesses the unique establishment ID for that establishment by using one of a plurality of methods. In a first method, an RFID scanner on the portable computing device reads an RFID chip within the establishment and thereby receives the Establishment ID. In a second method, a GPS transducer on the portable computing device determines a current geospatial coordinate for the user. A software process uses that coordinate, indexed against a database of geospatial data associated with particular establishments, to access the unique Establishment ID of the particular establishment the user is currently located within. The user then engages a user interface of the portable computing device to cause it to send an attendance message to the EBPTM server, the attendance message including the unique establishment ID of the establishment and the unique user ID of the particular user. In some embodiments the portable computing device may display to the user a listing of a plurality of establishments that are in certain close proximity to the user's current geospatial location. The user may then select one of the plurality of establishments from the listing so as to identify the establishment that the user is currently in attendance within. Based at least in part upon the user selection of the establishment from the listing, the portable computing device of the user sends an attendance message to the EBPTM server, the attendance message including the unique establishment ID of the selected establishment and the unique user ID of the particular user. In some embodiments the geospatial data associated with each establishment may be stored within the Establishment Database, for example as spatial boundaries.

With respect to the functionality of the software running on the EBPTM server 100, in some embodiments of the present invention, a database of personal profile information for a plurality of users that is maintained and/or accessed by the EBPTM server 100 and is referred to herein as a Personal Profile Database (“PP Database”). In one example embodiment the Personal Profile Database is indexed by a unique user ID for each user of the system. Indexed with respect to a user's unique user ID is a set of personal characteristics that described that particular individual including but not limited to that person's age, gender, highest level of schooling, marital status, political party affiliations, school affiliations, team affiliations, club affiliations, organizational affiliations, hobbies, interests, profession, job title and/or hierarchy level within an organization, sexual orientation, annual income, sporting team preferences, status as a tourist or resident within the current geographic region, relationship status (i.e., whether in a relationship or looking for a relationship), musical preferences, IQ, entertainment preferences, food preferences, and/or other similar personal characteristics that describe an individual. In some embodiments the profile data also includes height and/or weight information for the user, and/or size information for the user with respect to clothing such as shirt size, pants size, and/or shoe size. In some embodiments the profile data also includes eye color and/or hair color of the user. In some embodiments the personal profile data also includes clothing taste information for the user, including preference towards particular clothing brands and/or styles of dress. In some embodiments the personal profile data include color preference data for the user. In many embodiments of the present invention a user enters their personal characteristics and/or preferences through a user interface upon registering for the service. In addition users of the present invention can update their personal characteristics as stored within the database from time to time as personal characteristics change. For example, if a user gets married he or she may update his or her personal characteristics related to marital status. In addition, the personal characteristics may include the user's birth date such that his or her age can be automatically updated by the software that maintains the Personal Profile Database and/or EBPTM application as his or her age changes over time. The personal profile database may also include an electronic address of a portable computing device of each of a plurality of users. In some embodiments an electronic address of the user is used as the unique ID of the user. In some embodiments an electronic address of the user is mapped through a relational association to the unique ID of the user, the unique ID of the user thereby being retrievable using one or more electronic addresses of portable computing devices of the user.

The EBPTM server 100 is also operative to maintain the aforementioned Establishment Attendance Database, current patronage data, and historical patronage data for each of a plurality of localized physical establishments. The current and historical data indicate the current and past patronage to each establishment by each of a plurality of users. In this way the EBPTM server 100 may access, by a unique establishment ID, a record of which patrons are currently present within an establishment and/or a record of which patrons have visited the establishment over a prior period of time. The EBPTM server 100 is also operative to maintain historical data for each of a plurality of users, the historical data indicating the current and past patronage to each of a plurality of localized physical establishment visited by each user. In this way the EBPTM server 100 may access, by unique user ID, a record of which establishments were visited by the user over a prior period of time (indexed by unique establishment ID), as well as optionally accessing an indication of when the establishments were visited by the user. It should be noted that patron visits to establishments may be stored in the data stores such that it reflects the time, date, and/or day of week, that each patron visited each establishment. In addition, a record of how many times a particular patron has visited a particular establishment during a particular time period may be stored within the data store. In some embodiments of the present invention the EBPTM server 100 maintains data about each of the users that reflect their visiting behavior with respect to particular location based establishments such as, for example, an indication of which location based establishments have been visited by a particular user (indexed with respect to that users unique ID) and the frequency and/or number of times the user has visited each location based establishments. In addition the visiting behavior data may include the days-of-the-week and/or times-of-day that a particular user visited each location based establishment. Thus, the data may include a record of how many times a particular user visited a particular establishment on particular days of the week, during a particular prior period of time. In these ways, data may be stored, for example, indicating how many times a particular user visited a particular establishment on either Friday or Saturday night, over a period of the prior 90 days. In addition, the visiting behavior data may also include an indication of the duration of a particular patron's visit to a particular establishment.

Embodiments of the present invention may be generally configured such the EBPTM server 100 maintains a listing of which of a plurality of individual users are believed to be present within which of a plurality of establishments. To support this functionality, some embodiments maintain an Establishment User List in memory, which is a storage of the received User ID values for all users who are currently determined to be patronizing a particular establishment as indexed by that establishments unique Establishment ID. Thus, when a new User ID is received as correlated with a particular Establishment ID, that User ID is added to the Establishment User List for that establishment. In some embodiments the Establishment User List may also include an indication of how long of a time each particular patron is recorded as having been in current attendance within the particular establishment.

The Establishment User List may subsequently be used by the EBPTM server 100 to message some or all of the current patrons of the particular establishment. In some embodiments current patrons may be messaged based on a combination of factors including being a current patron of an establishment, i.e., currently visiting the establishment, as well as based upon possessing one or more demographic characteristics within the patron's personal profile data. In this way, for example, a message may be sent to the personal portable computing devices of all patrons who are currently visiting a particular localized physical establishment and who posses a particular demographic characteristic or characteristics such as, for example, who are all of a particular gender, all of a particular age or age-range, all have a particular musical taste preference, all have a particular clothing brand and/or style preference, all who have a particular food and/or drink preference, and/or all who are a particular clothing size. This provides a powerful real-time targeted messaging pathway for localized physical establishments, enabling them to message, in real-time, the current patrons visiting their establishment who posses certain demographic characteristics and/or taste preferences. In addition the messages may also be sent dependent upon each patron's historical patronage data for that particular establishment. For example, only patrons who are currently documented as being in attendance within the establishment and who have visited the establishment more than a certain number of other times within a particular prior time period are sent the particular promotional message for the particular establishment.

By using such combinations of factors, the present system may be configured to enable particular messages to be sent to particular patrons of particular establishments in highly targeted manner. In one embodiment, the system may be configured, for example, to automatically message the portable computing devices of all patrons who are currently visiting a particular clothing store who are female in gender as indicated by the gender data in their personal profile. In another embodiment, the system may be configured, for example, to automatically message the portable computing devices of all patrons who are currently visiting a particular restaurant who are partial to steak as indicated by the food preference data in their personal profile. In another embodiment, the system may be configured, for example, to automatically message the portable computing devices of all patrons who are currently visiting a particular bar and who are partial to beer as indicated by the food preference data in their personal profile. In another embodiment, the system may be configured, for example, to automatically message the portable computing devices of one or more patrons who are currently visiting a particular clothing store who are partial to a particular brand of clothing, for example Levi's brand pants as indicated by the clothing preference data in their personal profile. In another embodiment, the system may be configured, for example, to automatically message the portable computing devices of one or more patrons who are currently visiting a particular clothing store and who are of a particular pants size, as indicated by the clothing size data in their personal profile. In another embodiment the system may be configured, for example, to automatically message the portable computing devices of one or more patrons who are currently visiting a particular bar and who are unmarried as indicated by the marital status data in their personal profile. In other embodiment the system may be configured, for example, to automatically message the portable computing devices of one or more patrons who are currently visiting a particular bar, who are students of a particular college as indicated by the college affiliation data in their personal profile. In these ways, highly targeted messages may be automatically sent to patrons of an establishment based upon current patronage data used in combination with demographic characteristic data.

In addition, embodiments of the present invention may be configured to automatically message patrons who are currently visiting a particular establishment and who are recorded as having been present within the establishment for more than a particular amount of time. More specifically, the EBPTM server may be configured such that a plurality of current patrons of an establishment may be automatically messaged based at least in part upon an indication of each of the plurality of current patrons having been in current attendance within a particular establishment for more than a particular amount of time. For example, the EBPTM server may be configured to automatically send a particular message to the portable computing devices of one or more patrons who are documented as being in attendance within a particular establishment for more than 30 minutes. In this way, visit-duration dependent messages may be automatically deployed to one or more patrons of a particular establishment based upon current patronage data. In some such embodiments, visit-duration dependent messages may be configured to be automatically sent based upon window of time durations. For example, a particular electronic message may be sent to the portable computing devices of all patrons of a particular establishment who are documented as having been in attendance in a particular establishment for more than 20 minutes, but less than 40 minutes.

Rather than messaging current patrons of a particular localized physical establishment, embodiments of the EBPTM server 100 may be configured to send establishment-specific messages (for example establishment-specific promotional offers) to the portable computing devices of past patrons of a particular establishment based at least in part upon the historical record of their visits to the particular establishment over a prior period of time. In some embodiments, the patrons are messaged in response to the historical data indicating that they have visited the particular localized physical establishment during a particular prior time period. In other embodiments, the patrons are messaged in response to the historical data indicating that they have visited the establishment in the past, but have not visited the particular localized physical establishment during a particular prior time period. In some embodiments the patrons are messaged based, at least in part, upon the particular time of day and/or day of week that they have visited the particular establishment in the past. In some embodiments the patrons are messaged based, at least in part, upon the number of times the patron has visited the particular establishment during a prior time period. In some embodiments patrons are messaged based upon a combination of the number of times they have visited the particular establishment, the time of day and/or day of week they have visited the particular establishment, and/or the amount of time that has passed since they have last visited the particular establishment. In some embodiments patrons are messaged based upon the amount of time they have spent visiting a particular localized physical establishment. The amount of time may be determined based upon visit duration data stored within the attendance database. The visit duration may be the duration of a current visit stored in the current patronage data or may be a duration of a previous visit stored in the historical patronage data. In addition an average or cumulative visit duration may be stored across a plurality of separate visits by a particular user to a particular establishment.

In some embodiments prior patrons may be messaged based on a combination of factors including the fact that they are documented as a prior patron of an establishment, i.e., are determined to have previously visited the establishment during a prior period (using one or more of the limitations described above), as well as based upon possessing one or more demographic characteristics associated the patrons as stored within the personal profile data for each. In this way, for example, a message may be sent to the personal portable computing devices of all patrons who are have visited a particular localized physical establishment over prior time period and who all posses a particular demographic characteristic or characteristics, for example who are all of a particular gender, all of a particular age or age-range, all have a particular musical taste preference, all have a particular clothing brand and/or style preference, all who have a particular food and/or drink preference, and/or all who are a particular clothing size. This provides a powerful real-time targeted messaging pathway for localized physical establishments, enabling them to message, in real-time, the prior patrons of their establishment who posses certain historical patronage characteristics and who posses certain personal demographic characteristics and/or taste preferences.

For example, the EBPTM server 100 may be configured when sending a promotional message out for a particular establishment such that only patrons who have visited the particular establishment more than a certain number of times within a particular time period (as indicated by the historical patronage data for each user) and who are students at a particular university (as indicated by the personal profile data for each user) is sent the particular promotional message for the particular establishment.

Similarly, embodiments of the present invention may be used, for example, to automatically select and message one or more patrons who have visited a particular restaurant at least once within the last 90 days, as indicated by the historical patronage data for that user, and who are female in gender, as indicated by the gender data in their personal profile, with a particular promotional message sent to the portable computing devices of those patrons. The particular promotional message may be an alert to an upcoming Ladies Night event at the particular restaurant. The particular message may be automatically selected from a plurality of stored messages within the Promotional Message Database based upon, for example, a stored relational association with a female gender indicator.

Similarly, embodiments of the present invention may be used, for example, to select and message all patrons who have visited a particular restaurant at least once within the last 90 days, as indicated by the historical patronage data for that user, and who are partial to steak, as indicated by the food preference data in their personal profile, with a particular promotional message sent to the portable computing devices of those patrons. The particular promotional message may be an alert to an upcoming steak special at the restaurant.

Similarly, embodiments of the present invention may be used, for example, to message all patrons who have visited a particular bar at least once within the last 30 days, as indicated by the historical patronage data for that user, and who are partial to stout beer, as indicated by the food preference data in their personal profile, with a particular promotional message sent to the portable computing devices of those patrons. The particular promotional message may be an alert to an upcoming Stout Beer Fest event at the bar.

Similarly, embodiments of the present invention may further be used, for example, to automatically message patrons who have visited a particular coffeehouse at least once within the last year but not at all within the last 90 days, as indicated by the historical patronage data for that user, and who are partial to mocha, as indicated by the food preference data in their personal profile, with a particular promotional message sent to the portable computing devices of those patrons. The particular promotional message may be an alert to an upcoming Mocha Madness event at the coffeehouse.

Similarly, embodiments of the present invention may be used, for example, to message one or more patrons who have visited a particular clothing store at least once within the last year but not at all within the last 90 days, as indicated by the historical patronage data for that user, and who are partial to Levi™ jeans, as indicated by the clothing preference data in their personal profile, with a particular promotional message sent to the portable computing devices of those patrons. The particular promotional message may be an alert to an upcoming Levi™ jeans sale at the clothing store. The particular message may be automatically selected from a plurality of stored messages within the Promotional Message Database based upon, for example, a stored relational association with a Levi's brand indicator.

Embodiments of the present invention may also be used, for example, to message all patrons who have visited a particular coffeehouse at least once within the last year but not at all within the last 90 days, as indicated by the historical patronage data for that user, and who are a pants size of 32, 34, or 36 as indicated by the clothing size data in their personal profile, with a particular promotional message sent to the portable computing devices of those patrons. The particular promotional message may be an alert to an upcoming pants sale on size 32 to 36 pants at the clothing store. The particular message may be automatically selected from a plurality of stored messages within the Promotional Message Database based upon, for example, a stored relational association with one or more of the sized 32 to 36.

Similarly, the present invention may be used, for example, to message all patrons who have visited a particular bar at least once within the last 90 days, as indicated by the historical patronage data for that user, and who are single in marital status, as indicated by the marital status data in their personal profile, with a particular promotional message sent to the portable computing devices of those patrons. The particular promotional message may be an alert to an upcoming Singles Night event at the particular bar. The particular message may be automatically selected from a plurality of stored messages within the Promotional Message Database based upon, for example, a stored relational association with a “single” marital status demographic indicator.

Embodiments of the present invention may also be used, for example, to message all patrons who have visited a particular bar at least once within the last 90 days, as indicated by the historical patronage data for that user, and who are students of a particular college, as indicated by the school affiliation data in their personal profile, with a particular promotional message sent to the portable computing devices of those patrons. The particular promotional message may be an alert to an upcoming event at the particular bar that is tailored to students of the particular college.

Similarly, embodiments of the present invention may be used, for example, to message a plurality of prior patrons who have previously visited a particular establishment during particular days of the week. For example, the system may be configured to automatically select and message a plurality of prior patrons who are documented in the historical patronage data as having been in attendance within a particular establishment on either a Friday or a Saturday during the last 90 days. In this way, an automated and highly targeted messaging process may be employed that targets patrons of an establishment who are likely to be partial to visiting the establishment during those particular days of the week. In addition, particular times of day may be used in combination with the particular days of the week in the automatic selection and messaging process. In this way the system may be configured, for example, to automatically select and message patrons who are documented within the historical patronage data as having been in attendance within a particular establishment during dinner hours on either a Friday or a Saturday during the last six months. The period of dinner hours may be defined by a range of hours, for example the hours between 5 PM and 9 PM.

Similarly, embodiments of the present invention may be used, for example, to message all patrons who have visited a particular bar at least once within the last 90 days, as indicated by the historical patronage data for that user, and who are partial to Hard Rock music, as indicated by the musical taste data in their personal profile, with a particular promotional message sent to the portable computing devices of those patrons. The particular promotional message may be an alert to an upcoming hard rock performance event at the particular bar.

Embodiments of the present invention may also be used, for example, to message all patrons who have visited a particular restaurant at least once within the last 180 days, as indicated by the historical patronage data for that user, and who are partial to country music, as indicated by the musical taste data in their personal profile and who are 13 to 18 years old as indicated by the age data in their personal profile, with a particular promotional message sent to the portable computing devices of those patrons. The particular promotional message may be an alert to an upcoming country music event for teens at the particular restaurant.

Similarly, embodiments of the present invention may be used, for example, to message all patrons who have visited a particular restaurant at least twice within the last 90 days during lunch time hours, as indicated by the historical patronage data for that user. The particular promotional message may be an alert to a current lunch special the particular restaurant. The period of lunch time hours may be defined by a range of hours, for example the hours between 11 AM and 2 PM.

An example of a message sent to a patron of an establishment based upon historical patronage data is shown in FIG. 2A. As shown in the figure, an SMS text message has been sent to the portable computing device of the patron, informing the patron that “Joe's Bar and Grill is now offering a free beer to all customers who arrive in the next 45 minutes . . . Come Quick!!!” In this way the EBPTM server 100 enables the establishment to send a real time promotional message directly to a computing device of a known previous patron to that establishment and encourage that patron to come in quickly. This enables an establishment to react to real-time downturns in patronage and attract known patrons to come quickly for a promotional special or event. Such an establishment-specific promotional message is a promotional offer because it conveys a free or discounted product or service of the establishment to which it relates. Such an establishment-specific promotional message is time-limited in that it may only be redeemed by the user within a particular time period from which it was conveyed to the user. In some embodiments the promotional message also includes a password or code key that the user must use to redeem the promotional offer. Thus, the promotional message may include a time-dependent password that is valid for the time-limited period of time, within the particular establishment to which the message relates. In some embodiments the user must provide the password or code key to an employee of the establishment in order to redeem the free or discounted service or product of the establishment.

FIG. 2B illustrates a message sent to a patron of an establishment based upon current patronage data according to an embodiment of the invention. As shown, an SMS text message has been sent to the portable computing device of the patron, informing the patron that the establishment that he or she is currently patronizing has a new appetizer and that a promotional offer exists with respect to the new appetizer if the user orders it within the next thirty minutes. The message conveyed is “Try our new appetizer, Atomic Fries, the spiciest fries you will ever eat! Half price for the next 30 minutes . . . ” In this way, the EBPTM server 100 enables the establishment to send a real time promotional message directly to a computing device of a current patron to that establishment and encourage that patron to order a new product of that establishment in a timely manner. Such an establishment-specific promotional message is a promotional offer because it conveys a free or discounted product or service of the establishment to which it relates. Such an establishment-specific promotional message is time-limited in that it may only be redeemed by the user within a particular time period from which it was conveyed to the user. In some embodiments the promotional message also includes a password or code key that the user must use to redeem the promotional offer. Thus, the promotional message may include a time-dependent password that is valid for the time-limited period of time, within the particular establishment to which the message relates. In some embodiments the user must provide the password or code key to an employee of the establishment in order to redeem the free or discounted service or product of the establishment.

Thus, whether it is based on current patronage of a particular establishment, past patronage of a particular establishment, or a combination of current and past patronage, embodiments of the present invention enable establishment-specific promotional messages to be conveyed directly to the portable computing devices of user who are known patrons of the particular establishment. As described previously, the promotional message may be selected based at least in part upon one or more demographic characteristic stored within the personal profile data for the particular patron. Thus, in some embodiments, a plurality of possible promotional messages related to the particular establishment is stored within a Promotional Message Database upon the EBPTM server 100 (or accessible to the EBPTM server 100). At least one of the promotional messages is selected from the plurality of available promotional messages, based at least in part upon one or more demographic characteristic of the particular patron as stored in the personal profile data for that patron. A plurality of promotional messages may be stored in the promotional message database, each promotional message relationally associated with one or more demographic characteristics. A message is then selected for the particular patron based upon better match between the one or more demographic characteristics that are relationally associated with the selected promotional message as compared to the match with the demographic characteristics that are relationally associated with other of the plurality available promotional messages associated with the particular establishment.

An example is provided to make this clear. In one example a Promotional Message Database (PM Database) is stored upon the EBPTM server 100, the database including six promotional messages that are relationally associated with each of 100 different localized physical establishments. Three of the six promotional messages for each establishment are relationally associated with Male gender demographic characteristics, and three of the six promotional messages for each establishment are relationally associated with Female gender demographic characteristics. Of the three male gender associated messages for each establishment, one is related to Age demographic characteristics that are below 25 years old, one is related to Age demographic characteristics that are between 26 and 44 years old, and one is related to Age demographic characteristics that are 45 years old and beyond. Similarly, of the three female gender associated messages for each physical establishment, one is related to Age demographic characteristics that are below 25 years old, one is related to Age demographic characteristics that are between 26 and 44 years old, and one is related to Age demographic characteristics that are 45 years old and beyond. Thus, six separate promotional messages are relationally associated with each of 100 separate localized physical establishments, each of the six separate promotional messages being relationally associated with a different age-gender demographic characteristic combination.

In the example scenario above, a patron walks into a particular establishment and sends an Attendance Message to the EBPTM server 100 informing the server as to his presence within the particular establishment. He does this by texting the establishment ID to the EBPTM server 100 in a message of the format “#345324” which is simply a number sign followed by the unique establishment ID of that establishment. The EBPTM server 100 parses the message, accesses the return phone number of the user, and uses that return phone number as the unique ID of that user. The EBPTM server 100 thus has the unique ID of the user (his phone number) and the unique ID of the establishment (345324). The EBPTM server 100 then updates the Establishment Attendance Databases to indicate that the particular user is currently present within the particular localized physical establishment. This data store may include storing historical information as to the time and/or date that the particular user visited the particular establishment. In response to the attendance message, either while the patron is still visiting the establishment, or after the patron has left the establishment, a promotional message that is relationally associated with the particular establishment is sent to the portable computing device of the particular user. This promotional message is selected from the Promotional Message Database, indexed by the unique ID of the establishment and indexed using a plurality of demographic characteristics of the particular user. The demographic characteristics are accessed from the personal profile information stored on (or accessible to) the EBPTM server 100, indexed by the unique ID of the user. In this example the data accessed indicates that the user is MALE and the user is 34 Years Old.

Using the demographic data (user=male, and user=34 years old) along with the establishment ID (ID=345324), a particular promotional message is selected from the Promotional Message Database that is relationally associated with the user ID of the establishment and is relationally associated with demographic characteristics that better match the demographic characteristics of the particular user than other of the promotional messages associated with the particular establishment. The selected promotional message is then sent to the portable computing device of the particular user. This is done using the unique electronic address for the portable computing device of the particular user as accessible to the EBPTM server 100, indexed by the unique user ID of the user. In this way the present invention enables a targeted promotional message to be sent to a user based at least in part upon that user having patronized a particular localized physical establishment and based at least in part upon one or more demographic characteristics of the particular user.

In some embodiments the messages sent from the portable computing devices to the EBPTM server 100, indicating the user of that portable computing device is now present within the establishment, are triggered automatically based upon signals received by the portable computing device from transmitters within or near a particular location based establishment. For example, upon approaching, entering, or residing within a particular establishment a portable computing device such as an appropriately enabled cell phone computing device on the person of a user may receive a signal (e.g., a radio signal) indicating that the device is now within a particular establishment. The signal may include the encoded Establishment ID for that establishment. Upon receiving such a signal, the portable computing device may be configured to automatically send a message to the EBPTM server 100 over a wireless communication link, the messaging indicating to the EBPTM server 100 the User ID of the user of the portable computing device, the Establishment ID of the establishment in question, and optionally a time stamp. The radio signal may be, for example, an RFID signal or other localized radio signal.

In some embodiments, the portable computing device of a patron may send a message to the EBPTM server 100 indicating that the user has left the premises of a particular localized physical establishment. The EBPTM server 100 then updates the Establishment User List for that establishment, removing the unique user ID or other indicator for that user from the list for the establishment that he or she just left. In some such embodiments, the user is removed from the list automatically after a certain elapsed time has passed from the time the EBPTM server 100 received the visit indication. For example, in some embodiments the EBPTM server 100 removes a user from the Establishment User List (n) minutes after receiving the indication of presences of that user within the establishment, where (n) is a number that may be set depending upon the type of establishment. As used herein, (n) is referred to as the time_out_period for the particular establishment. If the establishment is a restaurant, (n) may be set, for example, to 90 minutes. If the establishment is a retail store (n) may be set, for example, to 20 minutes. If the establishment is a movie theater, (n) may be set, for example, to 120 minutes. In this way a user may be removed from the Establishment User List some anticipated amount of time after being added to the list, unless the user sends a repeat message informing the EBPTM server 100 as to his or her continued patronage of the localized physical establishment. In this way the present invention enables a “tell us you're here” architecture for tracking the patronage of localized physical establishments by users of portable computing devices such that a patron is assumed to have departed the establishment some pre-configured amount of time after the last “tell us you're here” message is received by the EBPTM server 100 for that patron's visit to that particular establishment.

With respect to the Time_Out_Period variable described above, each unique establishment may have a unique Time_Out_Period associated with it. Thus the variable may be an array indexed by unique Establishment ID. This may be of the form:
Time_Out_Period (Establishment ID).

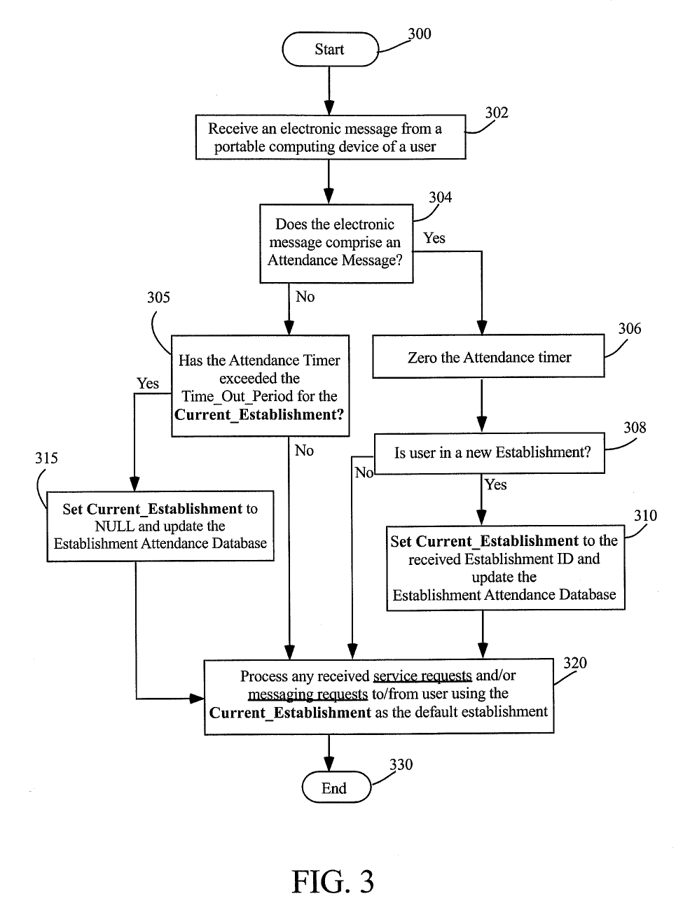

FIG. 3 illustrates a flowchart of an example process that supports the maintaining of the Establishment Attendance Database based upon received Attendance Messages and tracking of attendance time_outs for particular establishments according to an embodiment of the invention. As shown, the process starts at 300 where a subroutine, the subroutine being a background process that runs along side other processes. At 302 an electronic message is received by the EBPTM server 100, the electronic message being sent from a portable computing device 111 of a user. In general, the user is one of a plurality of users being serviced by the EBPTM server 100. The electronic message may be sent in a variety of forms. In one example embodiment the electronic message is an SMS text message sent from the portable computing device 111 of the user. The electronic message is parsed by the EBPTM server 100 to determine its contents and the type of message it comprises.

At step 304 a determination is made as to whether the electronic message comprises an Attendance Message. If it is an Attendance Message it will include an indication that the particular user has arrived within and/or is present within a particular establishment. The particular establishment will be identified by a unique Establishment ID. The particular user will be identified by a unique User ID which may be a unique value associated with the user and/or a unique address of the portable computing device of the user. If the message is an Attendance Message, it comprises a current indication that the identified user is present within the identified establishment. If so, the process branches to 306 wherein an Attendance Timer is set to zero. This time is an incremental timer that will count elapsed time from the moment it is zeroed, forward. Because every user will have a separate Attendance Timer related to the establishment that he or she is currently patronizing, The Attendance Timer variable is generally indexed with respect to the unique ID of the user. This is because each of a plurality of users has an Attendance_Timer variable associated with the current establishment they are in. Thus the Attendance_Timer variable may be an array indexed as follows:
Attendance_Timer (User_ID).

At step 306, Attendance_Timer(User_ID) using the ID of the current user is set to 0. Prior to this, Attendance_Timer(User_ID) may be a time value that indicates the elapsed time since the last time the value was zeroed.

The process then proceeds to 308 where a determination is made as to whether the establishment indicated by the received Attendance Message is a new establishment (i.e., has the user entered a new establishment) or is it the same establishment as one the user was previously in. This determination is made by comparing the Establishment ID received in the Attendance Message with a value stored in a Current_Establishment variable that indicates the current establishment that the user is patronizing. The Current_Establishment variable is generally indexed with respect to the unique ID of the user, because each of a plurality of users has a Current_Establishment variable associated with them. Thus the Current_Establishment variable may be an array indexed as follows:
Current_Establishment (User_ID)

It should be appreciated that if the user is not currently documented as being within an establishment at the current time, this variable is set to a NULL value. Thus, at step 308, a determination is made as to whether the user has entered a new establishment. If so, the process branches to 310 where the Current_Establishment variable for that user is updated. This is achieved by setting Current_Establishment for the current user to the Establishment ID that was received in the Attendance Message at 304. In addition, the Establishment Attendance Database is updated at 310, documenting the presence of the particular user within the particular establishment, optionally including time and date and day values for the visit. This documents the current establishment being patronized by the user. The process then proceeds to 320. If the determination made at 310 was such that the user was NOT in a new establishment (i.e. the Attendance Message indicated the same Establishment ID as the current establishment currently documented for the user), the process jumps directly to 320, without performing step 310.

At step 320, the EBPTM server 100 is operative to process any service requests and/or information requests received from the particular user using the Current_Establishment as the default establishment for the service request. For example, if the user sends a subsequent request asking for a digital menu to be downloaded, the EBPTM server 100 accesses and downloads the menu associated with the Current_Establishment. In this way, the user may make a variety of service requests to the EBPTM server 100, without again identifying a unique ID of a particular establishment, and the EBPTM server 100 will use the Current_Establishment value stored for that user at the current time. This is a convenience for the user, freeing him or her from repeatedly informing the server as to which establishment he or she is making service and/or information requests with respect to. At step 320, the EBPTM server 100 is also operative to process any pending messaging requests relating to the particular user using the Current_Establishment as the default establishment for the messaging request. For example, if there are any pending establishment-specific promotional messages relating to the Current_Establishment and to the current user, those messages will be forwarded to the current user at this time. Similarly, any pending person-to-person establishment-specific messages and/or establishment-specific reminder messages, relating to the Current_Establishment and the particular user, they will be forwarded to the particular user at this time. As described previously, the establishment-specific promotional messages may include promotional offers, the promotional offers optionally being time-limited promotional offers.

Referring back to step 304, if the message received from the user was not an Attendance Message, the process branches to 305. At step 305, the Attendance Timer is checked for the Current_Establishment is to see if the Time_Out_Period for that establishment has been exceeded by the current value of the Attendance Timer for the current user. Said another way, a conditional statement is executed checking:
if Attendance_Timer (User_ID)>Time_Out_Period (Establishment_ID)

If so, that means the user associated with the current User ID has been within the current establishment for a period of time that exceeds the Time_Out_Period for that establishment without a fresh Attendance Message being received. If this is the case, the process branches to 315 and the Current_Establishment is set to NULL. In other words, enough time has passed since the last Attendance Message was received form the current user to assume that the user is no longer within the establishment identified by the last Attendance Message. Thus the Current_Establishment is set to NULL. Also, the Establishment Attendance Database is updated to reflect the user as no longer being present within the previous Current Establishment. The process then proceeds to 320.

If the conditional statement in 305 above determined that the user associated with the current User ID has NOT been within the current establishment for a period of time that exceeds the Time_Out_Period for that establishment without a fresh Attendance Message being received, the process jumps directly to 320 without any changes being made. It should be noted that the Attendance_Timer variable is continually incremented over time using a background process. Finally, the process proceeds to 330 where the routine ends. In a typical embodiment it is immediately called again, starting again at 300. It should also be noted that in some embodiments a user may send an Exit Message to the EBPTM server 100, the Exit Message specifically indicating that the user has exited the current establishment. Such an Exit Message, upon receipt, causes the process of FIG. 3 to jump directly to step 315, which sets the Current Establishment to NULL and updates the Establishment Attendance Database accordingly.

Finally, in some embodiments the EBPTM server 100 stores a historical record of which establishment-specific promotional messages have been sent to which patrons. This record may be referred to herein as a Messaging Deployment Database. Thus, the messaging deployment database contains historical information as to which establishment specific promotional messages (indexed by a unique message ID) were sent to which users (indexed by unique User ID), as well as the time and date that the messages were sent. This Messaging Deployment Database may be used to prevent a patron from being sent the same establishment-specific promotional message and/or offer more than a certain number of times and/or more than once within a particular time period. This Messaging Deployment Database may also be correlated with the Establishment Attendance to determine if a particular user, after receiving a particular promotional message and/or offer that is relationally associated with a particular establishment, visits that particular establishment within a particular period of time. If so, it may be inferred that the establishment-specific promotional message and/or offer was effective in drawing the particular patron into the particular establishment. In this way the EBPTM server 100 may be configured to document the results of establishment-specific promotional messages and/or offers in regard to the subsequent visits to a particular establishment that closely follow in time the delivery of an establishment-specific promotional message for that particular establishment.

In some such embodiments a billing structure is enabled in which establishments are charged a fee by the EBPTM server 100 system provider in exchange for the delivery of establishment-specific promotional messages and/or offers to the portable computing devices of known patrons of an establishment. In some such embodiments the fee charged to a particular establishment based upon the number of establishment-specific messages sent by the EBPTM server 100 to portable computing devices of patrons of that establishment.

Finally, in some embodiments the establishment-specific promotional messages sent to patrons may include a code or other identifier that is redeemable within the establishment for a product or service, or a discount off a product or service. In some such embodiments, the code is a unique code specific to the particular offer to the particular patron. In some such embodiments a copy of the unique code is also sent to the Establishment Computer 199 and thus may be viewed by employees of the establishment. In this way an employee of the establishment may receive a code from a customer and confirm that it is the same code received from the EBPTM. This enables a checking method by which establishments may verify that a customer received a valid and actual promotional offer from the EBPTM server 100. In some embodiments an automatic verification process is run upon the Establishment Computer 199 to verify that the offer code received from a patron is the same as an offer code received from the EBPTM server 100. In other embodiments the verification process may be performed by the EBPTM server 100. In such embodiments the Establishment Computer 199 sends a copy of the code received from the patron to the EBPTM server 100 which verifies the code and sends back a verification message to the EBPTM server 100. In this way promotional offers sent directly to the portable computing devices of patrons, as described herein, may be verified for authenticity by the establishment upon attempted redemption by a customer.

As disclosed herein an establishment ID may be visually presented to patrons by being printed upon menus, doors, tables, and/or other physical locations within a particular localized physical establishment. In addition the establishment ID may be conveyed electronically to the portable computing device of a patron as disclosed in the parent applications that are incorporated herein by reference.

In addition, embodiments of the present invention may be configured to enable a user to request patronage information from the EBPTM server 100 relating to a particular establishment, the patronage information indicating the current customer makeup of that establishment as documented in the establishment attendance database. Examples of such patronage information are disclosed in co-pending patent application Ser. No. 11/383,197, the disclosure of which is incorporated herein by reference. Such patronage information may include an indication of the total number of patrons within an identified establishment, the percentage of male or female patrons currently within an establishment, and/or a demographic breakdown of patrons by age group, school affiliation, sports team preferences, music preferences, and/or group affiliations.

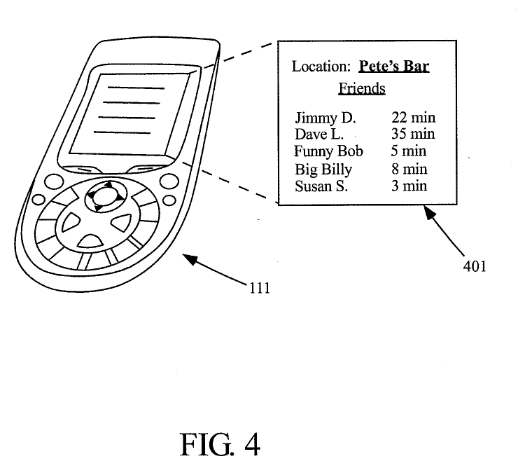

In some such embodiments a user may request information indicating if any friends are currently documented as being present within a particular establishment. This may be performed by a user sending a patronage profile request to the EBPTM server 100 relating to a particular localized physical establishment. In general the user sends a patronage profile request to the EBPTM server 100, the request including the unique establishment ID of the establishment for which the user desires current patronage profile information. The current patronage profile information that is returned to the computing device of the user, by the EBPTM server 100 may be numerical, for example including an indication of the number of friends present within the establishment, or may include a listing of unique identifiers for each friend that is currently present within the establishment. In one embodiment that supports such features, the Personal Profile Information stored for each user includes a Friends List that indicates a plurality of other users, by unique ID of each, that the profiled user considers friends. Thus, when that user sends a patronage profile request to the EBPTM server 100, the server accesses the Establishment User List for that establishment, accesses the Friends List for that user, and determines if any of the users who are listed on the Friends List for that user, are currently present on the Establishment User List for that establishment. If so, the EBPTM server 100 returns a message to the computing device of the requesting user, informing the requesting user as to the number or percentage of friends who are present within the identified establishment and/or returns a message with a listing of the friends, by name or handle or unique ID, who are present within the identified establishment. In this way, a user may send a patronage profile request to the EBPTM server 100, including the unique Establishment ID of a particular coffeehouse, and be returned an electronic message that includes a listing of any friends of that user who are currently present within that coffeehouse. FIG. 4 illustrates an example resulting display screen is for such an electronic message display according to an embodiment of the invention.

In the example shown in FIG. 4, a user sends a Patronage Profile Request to the EBPTM server 100 indicating the establishment ID of an establishment=Pete's Bar. The format of the Patronage Profile Request may take a variety of forms. In one embodiment it is a text message with the phrase “Profile” followed by the Establishment ID of the establishment for which the profile is desired. Thus an SMS text message may be sent by a particular user to the EBPTM server 100 of the form “PROFILE #3424” wherein 3424 is the unique establishment ID of the establishment “Pete's Bar”. The server is operative to parse the a coded request, access the databases as described above, and return a listing of friends of the requesting user (each presented by user names, handles, phone numbers, and/or other unique identifiers) who are currently present within Pete's Bar. This listing of users is then displayed upon the screen of the requesting user's device. An example of such a listing is shown as element 400. In addition to the names of the user, as shown, a value indicating the amount of time they have thus far been documented as being within the localized physical establishment may also be displayed upon the screen as shown. The resulting display may also include other profiling information with respect to the patronage of the identified establishment, such as the number of currently documented patrons and the gender makeup in percent male and percent female. Thus, the Patronage Profiling request may result in the determination, communication, and display of statistical measures of the current patronage of an establishment as well as a listing of current patrons of the establishment who are members of the requesting user's stored Friends List.

While the example of FIG. 4 shows a patron listing for a particular establishment provided to a particular user that comprises the intersection between the current patrons of that establishment (indexed by Establishment ID) and the members of a Friends List in the personal profile of the particular user (indexed by User ID), other groupings may be determined and displayed. For example, the particular user could identify a particular demographic characteristic, for example affiliation with a particular school, and request a patron listing for a particular establishment with respect to that demographic characteristic. In such an embodiment a user would request a Patronage Profile of an establishment (identified by unique Establishment ID) and identify one or more demographic characteristics that the user wishes a patronage profile with respect to. In this example the user might identify Gender=Female, and School Affiliation=U.C. Berkeley. The EBPTM server 100 is then operative to compile a listing a current patrons of the establishment (indexed by Establishment ID), who posses traits in their Person Profiles (indexed by each User ID), that match Gender=Female and School Affiliation=U.C. Berkeley. The EBPTM server 100 then returns a message to the requesting user that indicates the number of users documented as being with the identified establishment at the current time that match the demographic criteria. In this example, three such users are identified. In some embodiments a listing of their names, handles, electronic addresses, and/or user ID values are provided as well.

Additional disclosure of methods, apparatus, and computer program products for determining and displaying establishment-based patronage profiles that are based on one or more stored characteristics of current patrons of particular establishments is provided in co-pending patent application Ser. No. 11/383,197 by the present inventor, the disclosure of which is hereby incorporated by reference in its entirety.

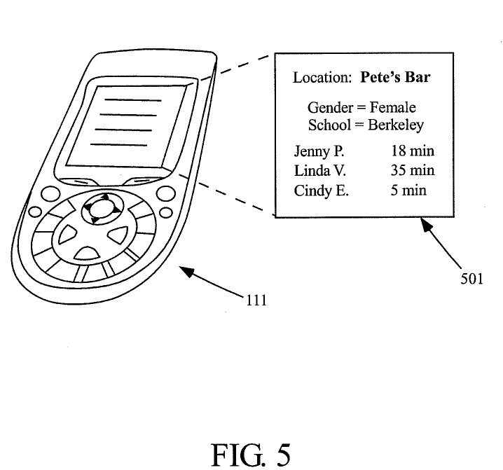

FIG. 5 illustrates a portable computing device configured with appropriate hardware and software to support the establishment-based patronage profiling features disclosed herein according to an embodiment of the invention.

This invention has been described in detail with reference to preferred and alternate embodiments. It should be appreciated that the specific embodiments described above are merely illustrative of the principles underlying the inventive concept. It is therefore contemplated that various modifications of the disclosed embodiments will, without departing from the spirit and scope of the invention, be apparent to persons of ordinary skill in the art.

The various exemplary embodiments described herein are merely illustrative of the principles underlying the inventive concept. It is therefore contemplated that various modifications of the disclosed exemplary embodiments will, without departing from the spirit and scope of the various exemplary invention embodiments will be apparent to persons of ordinary skill in the art. In particular, it is contemplated that functional implementation of the various exemplary embodiments described herein may be implemented equivalently in hardware, software, firmware, and/or other available functional components or building blocks.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method of providing a centralized establishment-based tracking and messaging service, the method comprising:
associating a unique establishment identifier with each of a plurality of physical establishments;
receiving at least one electronic attendance message from each of a plurality of portable computing devices, each electronic attendance message conveying a unique establishment identifier and a unique user identifier, each electronic attendance message indicating that a user associated with the unique user identifier is currently in attendance within a physical establishment associated with the unique establishment identifier;
storing, in a attendance database, current patronage data for each of a plurality of physical establishments, the current patronage data for each physical establishment including an indication of which of a plurality of individual users are identified as currently being in attendance within the physical establishment; and
sending at least one establishment-specific message to at least one portable computing device, the at least one establishment-specific message including content relating to a particular physical establishment of the plurality of physical establishments, the at least one establishment-specific message being sent to the at least one portable computing device in response to a message received from the at least one portable computing device that includes an establishment identifier associated with the particular physical establishment.

2. The method as recited in claim 1 wherein the plurality of portable computing devices are mobile telephone devices and wherein the at least one electronic attendance message is an SMS text message that includes the establishment identifier as message content.

3. The method of claim 1 further including storing historical patronage data for each of a plurality of physical establishments, the historical patronage data for each establishment including a history of user attendance within the establishment over a prior period.

4. The method of claim 3 wherein the historical patronage data includes, for each of a plurality of users, a record of at least one prior day of the week that the user was in identified as being in attendance within a particular physical establishment.

5. The method of claim 3 wherein the historical patronage data includes, for each of a plurality of users, a record of at least one prior time of day that the user was in identified as being in attendance within a particular physical establishment.

6. The method of claim 3 wherein the historical patronage data includes, for each of a plurality of users, a record of at least one prior duration of time that the user was in identified as being in attendance within a particular physical establishment.

7. The method of claim 3 wherein the at least one establishment-specific message is automatically selected by a software process from a plurality of stored establishment-specific messages, the selecting being performed based at least in part upon historical patronage data indicating that a user of the at least one portable computing device was in attendance within the particular establishment at least once during a particular previous period of time.

8. The method of claim 7 wherein the particular previous period of time is approximately equal to the previous 90 days.

9. The method of claim 3 wherein the at least one establishment-specific message is automatically selected by a software process from a plurality of stored establishment-specific messages, the selecting being performed based at least in part upon historical patronage data indicating that a user of the at least one portable computing device was previously in attendance within the particular establishment at least once during one or more particular days of the week.

10. The method of claim 9 wherein the one or more particular days of the week comprises Friday and Saturday.

11. The method of claim 3 wherein the at least one establishment-specific message is automatically selected by a software process from a plurality of stored establishment-specific messages, the selecting being performed based at least in part upon historical patronage data indicating that a user of the at least one portable computing device was previously in attendance within the particular establishment at least once during one or more particular times of day.

12. The method of claim 11 wherein the one or more particular times of day comprise a period between 11 AM and 2 PM.

13. The method of claim 1 wherein the at least one establishment-specific message is selected by a software process from a plurality of stored establishment-specific messages, the selecting being performed based at least in part upon the current patronage data indicating that a user of the at least one portable computing device has been in attendance within the particular establishment for more than a particular amount of time.

14. The method of claim 13 wherein the particular amount of time is approximately 30 minutes.

15. The method of claim 1 wherein the at least one establishment-specific message includes a numerical indication of a number of users recorded as being currently in attendance within the particular establishment.

16. The method of claim 1 wherein the at least one establishment-specific message includes a personal identifier of each of a plurality of users recorded as being currently in attendance within the particular establishment.

17. The method of claim 16 wherein the plurality of users is selected based it least in part upon a friends list that is relationally associated with a user of the at least one portable computing device.

18. The method of claim 1 wherein the at least one establishment-specific message is a promotional offer redeemable for at least one free or discounted product or service of the particular establishment.

19. The method of claim 18 wherein the promotional offer is only valid for a limited time period, the limited time period being designated within the establishment-specific message sent to the at least one portable computing device.

20. The method of claim 1 wherein the at least one establishment-specific message is a personal reminder, the personal reminder containing message content that was previously composed by the user of the at least one portable computing device and was relationally associated by the user with the particular physical establishment.

21. The method of claim 3 wherein the at least one establishment-specific message is automatically selected by a software process from a plurality of stored establishment-specific messages, the selecting being performed based at least in part upon the historical patronage data indicating that the user of the at least one portable computing device was previously in attendance within the particular establishment more than a predetermined number of times over a particular prior period of time.

22. The method of claim 1 further including storing personal profile data for each of a plurality of users, the personal profile data for each user including at least one demographic indicator associated with the user.

23. The method of claim 22 wherein the at least one establishment-specific message is automatically selected by a software process from a plurality of establishment-specific messages based at least in part upon the user of the at least one portable computing device having personal profile data that includes a demographic indicator specifying a particular gender.

24. The method of claim 22 wherein the at least one establishment-specific message is automatically selected by a software process from a plurality of establishment-specific messages based at least in part upon the user of the at least one portable computing device having personal profile data that includes a demographic indicator specifying an age value that matches a particular value or falls within a particular range.

25. The method of claim 22 wherein the at least one establishment-specific message is automatically selected from a plurality of establishment-specific messages based at least in part upon the user of the at least one portable computing device having personal profile data that includes a demographic indicator specifying a particular organizational affiliation.

26. The method of claim 22 wherein the at least one establishment-specific message is automatically selected by a software process from a plurality of establishment-specific messages based at least in part upon the user of the at least one portable computing device having personal profile data that includes a demographic indicator specifying a particular brand preference.

27. The method of claim 22 wherein the at least one establishment-specific message is automatically selected by a software process from a plurality of establishment-specific messages at least in part upon the user of the at least one portable computing device having personal profile data that includes a demographic indicator specifying a particular music preference.

28. The method of claim 1 further including altering the current patronage data for a particular establishment such that it no longer indicates that a particular user is in attendance within the particular establishment, the altering being performed in response to a minimum amount of time elapsing since the receipt of an attendance message indicating that the particular user is in attendance within the particular establishment.

29. The method of claim 1 further including altering the current patronage data for a particular establishment such that it no longer indicates that a particular user is in attendance within the particular establishment, the altering being performed in response to an attendance message being received indicating that the particular user is currently in attendance within a different physical establishment.

30. The method of claim 1 wherein the user identifier is a phone number of the portable computing device from which the attendance message was received.

31. A method of providing a centralized establishment-based tracking and messaging service comprising:
associating a unique establishment identifier with each of a plurality of physical establishments;
receiving at least one electronic attendance message from each of a plurality of portable computing devices, each electronic attendance message conveying a unique establishment identifier and a unique user identifier, each electronic attendance message indicating that a particular user associated with the unique user identifier is then currently in attendance within a physical establishment associated with the unique establishment identifier;
storing historical patronage data for each of a plurality of physical establishments, the historical patronage data for each establishment including a history of user attendance within the establishment over a prior period of time;
selecting using an automated software process, at least one portable computing device from the plurality of portable computing devices, the selecting being performed based at least in part upon the historical patronage data indicating that a user of the at least one portable computing device was previously in attendance within a particular physical establishment at least once during the prior period of time; and
sending at least one establishment-specific message to at least one portable computing device, the at least one establishment-specific message including content relating to the particular physical establishment.

32. The method of claim 31 wherein the at least one portable computing device is selected based at least in part upon historical patronage data indicating that the user of the at least one portable computing device was previously in attendance within the particular establishment at least once during a period of approximately the previous 90 days.

33. The method of claim 31 wherein the at least one portable computing device is selected based at least in part upon historical patronage data indicating that the user of the at least one portable computing device was previously in attendance within the particular establishment at least once during one or more particular days of the week.

34. The method of claim 31 wherein the at least one portable computing device is selected based at least in part upon historical patronage data indicating that the user of the at least one portable computing device was previously in attendance within the particular establishment at least once during one or more particular times of day.

35. The method of claim 31 further including storing personal profile data for each of a plurality of users, the personal profile data for each user including at least one demographic indicator associated with the user.

36. The method of claim 35 wherein the at least one portable computing device is also selected based at least in part upon the user of the at least one portable computing device having personal profile data that includes a demographic indicator specifying a particular gender.

37. The method of claim 35 wherein the at least one portable computing device is also selected based at least in part upon the user of the at least one portable computing device having personal profile data that includes a demographic indicator specifying an age value that matches a particular value or falls within a particular range.

38. The method of claim 35 wherein the at least one portable computing device is also selected based at least in part upon the user of the at least one portable computing device having personal profile data that includes a demographic indicator specifying a particular organizational affiliation.

39. The method of claim 35 wherein the at least one portable computing device is also selected based at least in part upon the user of the at least one portable computing device having personal profile data that includes a demographic indicator specifying a particular brand preference.

40. The method of claim 35 wherein the at least one portable computing device is also selected based at least in part upon the user of the at least one portable computing device having personal profile data that includes a demographic indicator specifying a particular music preference.

41. The method of claim 31 wherein the at least one portable computing device is a mobile phone device and wherein the at least one establishment-specific message is an SMS text message.

42. The method of claim 31 wherein the at least one establishment-specific message is a promotional offer redeemable for at least one free or discounted product or service of the particular physical establishment.

43. The method of claim 42 wherein the promotional offer is only valid for a limited time period, the limited time period being designated within the establishment-specific message sent to the at least one portable computing device.

44. The method of claim 42 wherein the at least one establishment-specific message includes a redemption code for use in redeeming the promotional offer.

45. The method of claim 31 wherein the at least one electronic attendance message is an SMS text message that includes the unique establishment identifier as message content.

46. The method as recited in claim 31 wherein the unique user identifier is at least one of a phone number and a text messaging address of the portable computing device from which the attendance message was received.

47. A centralized establishment-based tracking and messaging system comprising:
an attendance database for storing patronage data for each of a plurality of physical establishments, each establishments being associated with a unique establishment identifier;
a promotional message database, the promotional message database comprising a plurality of promotional messages that are each relationally associated with at least one physical establishment and at least one demographic characteristic;
a personal profile database for storing personal profile data for each of a plurality of users, the personal profile data for each user including at least one demographic characteristic associated with that user, each user associated with a unique user identifier;
one or more processors in processing communication with the attendance database, the promotional message database, and the personal profile database, the one or more processors executing routines operative to
receive at least one electronic attendance message from each of a plurality of portable computing devices, each electronic attendance message conveying an unique establishment identifier and a unique user identifier, each electronic attendance message indicating that a user associated with the unique user identifier is currently in attendance within a physical establishment associated with the unique establishment identifier,
update the attendance database based at least in part upon one or more received electronic attendance messages, the updating including the recording an indication that at least one user was in attendance within at least one establishment, and
send a particular promotional message to the portable computing device of a particular user, the particular user being associated with at least one received electronic attendance message, the particular promotional message being selected from among a plurality of promotional messages within the promotional message database based at least in part upon a demographic characteristic associated with the particular user in the personal profile database matching a demographic characteristic associated with the particular promotional message in the promotional message database.

48. The system of claim 47 wherein the particular promotional message is selected also based at least in part upon an establishment identifier associated with the particular promotional message in the promotional message database matching an establishment identifier received from the portable computing device of the particular user.

49. The system of claim 47 wherein the at least one demographic characteristic associated with each user is at least one of an age and a gender.
